(19) United States
(12) Patent Application Publication
(10) Pub. No.: US 2014/0214592 A1
(43) Pub. Date: Jul. 31, 2014

(54) METHOD AND SYSTEM FOR ONLINE RECOMMENDATION

(71) Applicant: International Business Machines Corporation, Armonk, NY (US)

(72) Inventors: Miao He, Beijing (CN); Jin Feng Li, Beijing (CN); Fei Liu, Beijing (CN); Tao Qin, Xian (CN); Chang Rui Ren, Beijing (CN); Bing Shao, Beijing (CN)

(73) Assignee: International Business Machines Corporation, Armonk, NY (US)

(21) Appl. No.: 14/165,628

(22) Filed: Jan. 28, 2014

(30) Foreign Application Priority Data
Jan. 31, 2013 (CN) 201310039291.0

(51) Int. Cl. G06Q 30/00

(52) U.S. Cl. CPC G06Q 30/00
USPC 705/26.7

(57) ABSTRACT

A technical solution for online recommendation. Determining, according to the first user's behaviors in the online decision process, which phase of the online decision process the first user is presented in, wherein the online decision process is divided into a plurality of phases depending on a decision conversion rate; selecting recommended items to be provided to the first user according to one or more second users' historical behavior records, wherein the one or more second users are users who are presented in one or more phases having a higher decision conversion rate than the determined phase.

### CROSS-REFERENCE TO RELATED APPLICATIONS

This application claims the benefit of priority of the State Intellectual Property Office of the People's Republic of China Patent Application Serial Number 201310039291.0, filed Jan. 31, 2013, which is hereby incorporated by reference in its entirety.

### FIELD OF THE INVENTION

The present invention relates to a computer-implemented method and apparatus, and more specifically, to an online recommendation method and system.

### BACKGROUND OF THE INVENTION

In the prior art, an online recommendation system has already been applied to provide recommended items to a user to help the user to make a purchase decision, for example, to buy goods, accept services, and download or subscribe content. For example, since users are inclined to purchase items which they were interested in the past, the recommendation system may perform item recommendation in a content based manner, wherein descriptions about the user or descriptions about items (any item that can be supplied, such as goods, services, and content) may be used. Again, for example, since similar users, or users making a purchase decision for similar items, usually have a high possibility to share the same purchase-decision-making intention for particular types of items, the recommendation system may perform item recommendation by collaborative filtering.

However, current recommendation systems all achieve recommendation of items for which a purchase decision is made, only based on the information about the purchase decision making. That is to say, current recommendation systems only consider users who have already made at least one online purchase decision and/or items for which the purchase decision is made (e.g., goods already bought, services already accepted, content already downloaded or subscribed), but they do not consider the user's acts before making the purchase decision and various content items that might be involved by the acts.

Therefore, a new online recommendation solution needs to be provided to more effectively provide the user with recommended items with richer content.

### SUMMARY OF THE INVENTION

In order to solve the problems existing in the prior art, embodiments of the present invention provide an online recommendation solution according to which a recommended item is selected based on a user's behavior records in each phase of the online purchase decision process so that the recommended items with richer content can be more effectively provided to the user and thereby the conversion rate of the online decision is improved.

According to an aspect of the present invention, there is provided a computer-implemented recommendation method. The method comprises: determining, according to a first user's behaviors in an online decision process, which phase of the online decision process the first user is presented in, wherein the decision process is divided into a plurality of phases depending on a decision conversion rate; selecting recommended items to be provided to the first user according to one or more second users' historical behavior records, wherein the one or more second users are users who are presented in one or more phases having a higher decision conversion rate than the determined phase.

According to another aspect of the present invention, there is provided a computer-implemented recommendation system. The system comprises: a phase detector configured to determine, according to a first user's behaviors in an online decision process, which phase of the online decision process a first user is presented in, wherein the online decision process is divided into a plurality of phases depending on a decision conversion rate; a recommendation engine configured to select recommended items to be provided to the first user according to one or more second users' historical behavior records, wherein the one or more second users are users who are presented in one or more phases having a higher decision conversion rate than the determined phase.

According to a further aspect of the present invention, there is provided a computer-implemented recommendation apparatus. The recommendation apparatus comprises: a module for determining, according to a first user's behaviors in an online decision process, which phase of the online decision process the first user is presented in, wherein the online decision process is divided into a plurality of phases depending on a decision conversion rate; and a module for selecting recommended items to be provided to the first user according to one or more second users' historical behavior records, wherein the one or more second users are users who are presented in one or more phases having a higher decision conversion rate than the determined phase.

As can be seen from the above, the present application creatively divides the online decision process into a plurality of phases according to the objective decision conversion rate reflected by the user's historical behaviors, then performs information recommendation according to the phase which the user is presented in and well solves the above problems existing in the prior art. Embodiments of the present invention can technically improve accuracy and customization of the online recommendation so that the provided recommended items can better satisfy the user's actual demands at the current phase, thereby effectively pushing the first user to convert to the phase having a higher decision conversion rate, and thereby effectively improving the decision conversion rate of the whole decision process.

### BRIEF DESCRIPTION OF THE SEVERAL VIEWS OF THE DRAWINGS

Through the more detailed description of embodiments of the present disclosure in the accompanying drawings, the above and other objects, features and advantages of the present disclosure will become more apparent, wherein the same reference numerals generally refer to the same components in the embodiments of the present disclosure.

FIG. 1 shows an exemplary computer system/server in which embodiments of the present invention may be implemented.

FIG. 2 illustrates a flow chart of a recommendation method according to an embodiment of the present invention.

FIG. 3 illustrates an example of allocating a weight for each phase of the online purchase decision process according to an embodiment of the present invention.

FIG. 4 illustrates a block diagram of a recommendation system according to an embodiment of the present invention.

### DETAILED DESCRIPTION

Embodiments of the present disclosure will be described in more detail with reference to the accompanying drawings, in which the embodiments have been illustrated. However, the present disclosure can be implemented in various manners, and thus should not be construed to be limited to the embodiments disclosed herein. On the contrary, those embodiments are provided for the understanding of the present disclosure, and conveying the scope of the embodiments to those skilled in the art.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with a computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

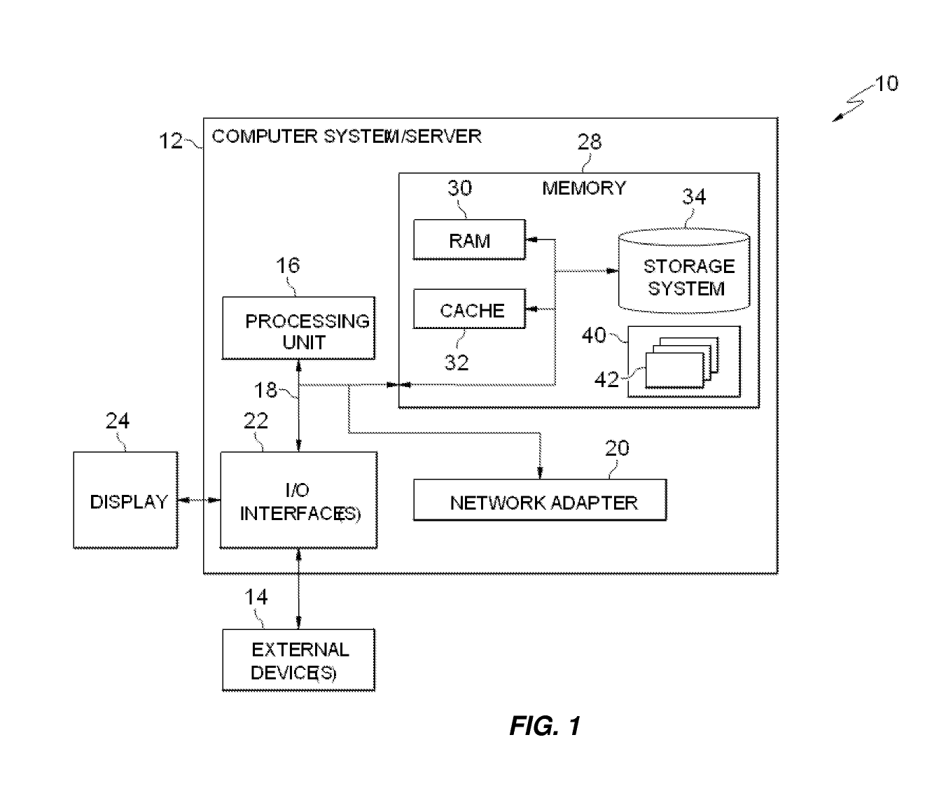

Referring now to FIG. 1, an exemplary computer system/server 12 on which embodiments of the present invention may be implemented is shown. Computer system/server 12 is only illustrative and is not intended to suggest any limitation as to the scope of use or functionality of embodiments of the invention described herein.

As shown in FIG. 1, computer system/server 12 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Further, computer system/server 12 may communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

As stated above, current recommendation systems only consider users who already make at least one online purchase decision and/or items for which the purchase decision is made (e.g., goods already bought, services already accepted, content already downloaded or subscribed), but they do not consider the user's acts before making the purchase decision and various content items that might be involved by the acts. However, in fact, the user's acts before making the online purchase decision can reflect his degree of impulsiveness for making the purchase decision for one item. These acts for example may includes: browsing operation B for a certain item, for example, browsing time B-time, browsing frequency B-Freq and the like; comparison C of items, e.g., the number of items being compared C-Num; marking M for items; putting an item into favorites, a shopping cart or the like P. Again for instance, these acts may further include consulting in different aspects by an online user for items. Different content of consultation may reflect different degree of impulsiveness of the user. For example, using a refrigerator as an online purchase decision process, if a user consults about color of a product, this might mean that the user has weak purchase impulsiveness; if the user consults about information about a compressor of the refrigerator or information about promotion, this might mean that he has strong purchase impulsiveness. Various embodiments of the present invention analyze the user's act before making the online purchase decision during the phases of the online purchase decision process, so as to more effectively provide a recommended item which is capable of better satisfying the user's actual needs in the current phase.

In the following text, for ease of description, the online purchase decision is used as a specific example of the online decision. However, those skilled in the art appreciate that various embodiments of the technical solution of the present invention are not limited to the online purchase decision process, but they can be applied to any online decision process adapted to employ the recommendation system. The examples and/or symbolized expressions as stated above will be used to simplify depiction of various embodiments of the present invention.

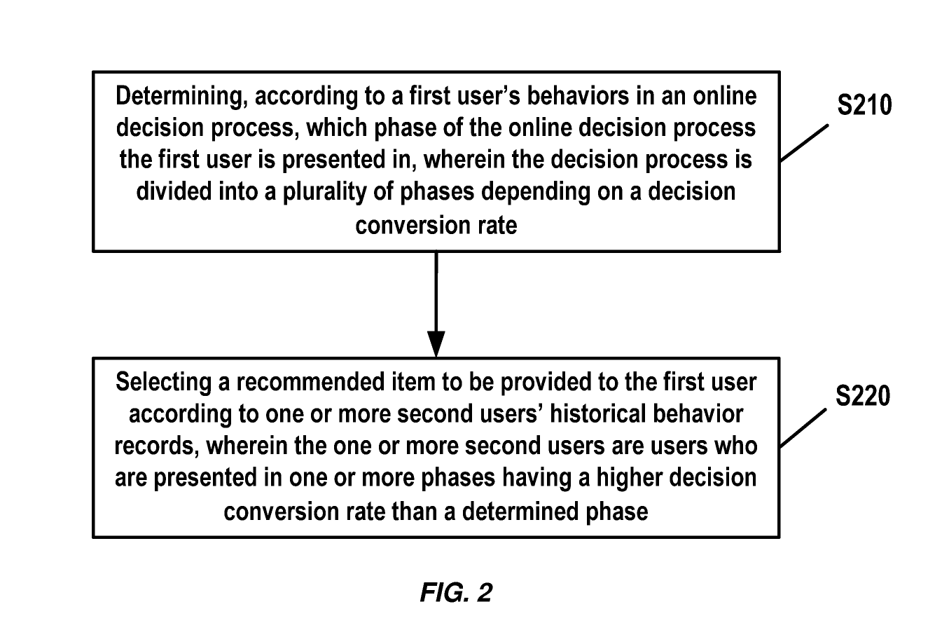

FIG. 2 illustrates a flow chart of a recommendation method according to an embodiment of the present invention.

At step S210, it is determined, according to a first user's behaviors during the online decision process, which phase of the online decision process the first user is presented in.

The online decision process is a cognitive process. Take the online purchase decision process as an example. Typically, the purchase decision process may be roughly divided into a demand raising phase, an information search phase, an alternative comparing phase and a purchase decision-making phase. However, division of the above phases is only a qualitative analysis of the user's behaviors. Therefore, it is difficult to monitor and detect the user's phase according to the prior art and thereby provide different recommended items according to different phases in which the user is presented in a quantitative way.

In order to quantitatively analyze the phase of the decision process in which the user is presented, the decision process is divided into a plurality of phases depending on a decision conversion rate according to various embodiments of the present invention. According to an embodiment of the present invention, the decision conversion rate may be defined as a ratio of the number of users having specific behaviors and having made the decision to purchase to the total number of users having the specific behaviors.

For instance, during the online purchase decision process, let i represents an index of a user who has already performed online operations towards a particular type of item, and N represent the number of users, then the purchase decision conversion rate CR may be evaluated as follows:

$$CR ( B = True , B - time > Value , C = True ) = \frac{{\sum }_{i = 1}^{N} {I}_{i} \{ B , B - time , C \} {I}_{i} \{ purchase \}}{{\sum }_{i = 1}^{N} {I}_{i} \{ B , B - time , C \}} \qquad ( 1 )$$

wherein I{•} represents an indicator function; when the statement acted upon by I is “true”, a value of the indicator function is “true”, otherwise the value of the indicator function is “false”. Equation (1) takes into account the user's behaviors: the browsing operation, the browsing time and comparison operation. Equation (1) is only a specific example of estimating the purchase decision conversion rate. Those skilled in the art may appreciate that the purchase decision conversion rate may also be evaluated in view of the user's other behaviors.

In another example, let j represents an index of a user who has already performed consulting operation towards a particular type of item, and M represent the number of users, then the purchase decision conversion rate may be evaluated as follows:

$$CR ( color , promotion ) = \frac{{\sum }_{j = 1}^{M} {I}_{j} \{ color , promotion \} {I}_{i} \{ purchase \}}{{\sum }_{j = 1}^{M} {I}_{i} \{ color , promotion \}} \qquad ( 2 )$$

wherein I{•} represents an indicator function; when the statement acted upon by I is “true”, a value of the indicator function is “true”, otherwise the value of the indicator function is “false”. Equation (2) takes into account the user's behaviors of consulting color of the item and information about promotion towards a particular item. Equation (2) is only a specific example of estimating the purchase decision conversion rate. Those skilled in the art may appreciate that the purchase decision conversion rate may also be evaluated in view of other aspects of the item consulted by the user.

According to the above definition of the decision conversion rate, according to an embodiment of the present invention, the online decision process may include a decision-making phase which has a decision conversion rate equal to 1.

Again, the example of the online purchase decision process is taken into consideration. According to the above definition of the purchase decision conversion rate, the corresponding purchase decision conversion rate may be evaluated with respect to various users' historical behaviors and combination of those historical behaviors, and the online purchase decision process is divided into phases based on the purchase decision conversion rate. For example, an exemplary phase division can be represented in Table 1:

TABLE 1

| Purchase intention | Purchase conversion rate |
|---|---|
| Weakest | <0.3% |
| Weak | 0.3-0.8% |
| Middle | 0.8-1.5% |
| Strong | 1.5-2.7% |
| Strongest | >2.7% |

Those skilled in the art may appreciate that if desired, the user can divide the phase as fine-granular as possible so long as there is enough users' historical behavior data to support the corresponding purchase decision conversion rate estimation.

According to an embodiment of the present invention, estimation of the decision conversion rate is performed before performing step S210, and the decision process are divided into phase according to the decision conversion rate, and the user's behaviors and/or combination of behaviors allocated to the phases are stored. For example, the following Table 2 may be stored in the system as criteria for dividing the purchase decision process into phases.

TABLE 2

| Phase 1: weakest | Phase 2: weak | Phase 3: middle | Phase 4: strong | Phase 5: strongest |
|---|---|---|---|---|
| CR(B, B-freq < 2) = 0.03% | CR(B, 2 ≦ | CR(B, 4 ≦ | CR(B, 8 ≦ | CR(B, |
| CR(color) = 0.15% | B-freq < 4) = 0.35% | B-freq < 8) = 0.9% | B-freq < 10) = 1.52% | B-time > 10 m) = 3.1% |
| CR(M) = 0.23% | CR(M, B) = 0.72% | CR(M, B ,C) = 1.2% | CR(M, B, C, P) = 2.0% | CR(promotion, |
| . . . | CR(C, B, | CR(color, | CR(color, | product structure) = 2.8% |
| | C-num = 1) = 0.41% | promotion) = 1.13% | promotion) =2.23% | CR(M, C, |
| | . . . | . . . | . . . | C-num) = 3.8% |
| | | | | . . . |

Therefore, at step S210, the phase of the online purchase decision process in which the first user is presented may be determined according to the user's behaviors in the online purchase decision process. For example, when the first user is detected to browse an item refrigerator less than twice, or the first user is detected to only consult the color of the item, or the first user is detected to only mark refrigerator as the item, it may be determined that the first user is presented in phase 1 of the online purchase decision process, and the user has a weakest purchase intention; when the first user is detected to browse the item refrigerator more than ten times, or the first user is detected to simultaneously mark, browse and compare the item and put it in the shopping cart, or the first user is detected to consult the color and promotion of the item, it may be determined that the first user is presented in phase 4 of the online purchase decision process, and the user has a strong purchase intention; and the like.

At step S220, recommended items provided to the first user are selected according to historical behavior records of one or more second users. According to the embodiment of the present invention, the one or more second users are users who are presented in one or more phases having a higher decision conversion rate than the determined phase. This is because the items or item-related information concerned by the users in the phases having a higher decision conversion rate is probably the information which is to be searched by the user in a phase having a lower decision conversion rate so as to facilitate his decision conversion. Providing corresponding recommended items purposefully for the first user can effectively shorten the time needed by the first user to perform operations such as searching information and comparing products so as to facilitate his decision making.

The above example of the online purchase decision process continues to be considered. Under the circumstance that the first user has already been determined to be presented in phase 2 of the online purchase decision process, the second user may be selected from users presented in phase 3, phase 4, and phase 5, and users who have already made the purchase decision.

According to an embodiment of the present invention, one or more users similar to the first user may be determined from users presented in phases with a higher decision conversion rate than the phase determined for the first user, so as to serve as said one or more second users. As such, potential decision makers having similar properties and preferences may provide personalized information which may be used by the first user in the decision conversion, so as to facilitate his decision making.

For example, according to an implementation mode of the purchase decision process, calculation may be performed for similarity between the first user and users presented in one or more phases with a higher purchase decision conversion rate than the determined phase. If the similarity of purchase behaviors between the first user and another user is greater than a certain threshold, said another user may be determined to be similar to the first user.

The similarity between two users may be calculated in any suitable manner.

For example, the similarity between users may be measured by using the nearest distance. Euclidean distance d may be used for continuous variables to measure the similarity between users:

$$d ( p , q ) = d ( q , p ) = \sqrt{{( {q}_{1} - {p}_{1} )}^{2} + {( {q}_{2} - {p}_{2} )}^{2} + … + {( {q}_{n} - {p}_{n} )}^{2}} = \sqrt{{\sum }_{i = 1}^{n} {( {q}_{i} - {p}_{i} )}^{2}} . \qquad ( 3 )$$

wherein p and q are vectors of the product purchased by users.

Jaccard distance may be used for discrete variables to measure the similarity between users:

$$J ( A , B ) = \frac{\vert A ⋂ B \vert}{\vert A ⋃ B \vert} . \qquad ( 4 )$$

wherein A and B are sets of products purchased by users.

Again, for example, a Cosine-based similarity may be used:

$$sim ( x , y ) = cos ( {x}^{->} , {y}^{->} ) = \frac{{x}^{->} \cdot {y}^{->}}{{‖ {x}^{->} ‖}_{2} \times {‖ {y}^{->} ‖}_{2}} = \frac{{\sum }_{i ∈ {I}_{xy}} {r}_{x , i} {r}_{y , i}}{\sqrt{{\sum }_{i ∈ {I}_{xy}} {r}_{x , i}^{2}} \sqrt{{\sum }_{i ∈ {I}_{xy}} {r}_{y , i}^{2}}} \qquad ( 5 )$$

wherein x, y represent vectors of the product purchased by users, r_{x,i} and r_{y,i} represent the ith elements in the vectors x, y respectively.

Again, for example, a correlation-based similarity may be used:

$$sim ( x , y ) = \frac{{\sum }_{i ∈ {I}_{xy}} ( {r}_{x , i} - {\overline{r}}_{y} ) ( {r}_{y , i} - {\overline{r}}_{y} )}{\sqrt{{\sum }_{i ∈ {I}_{xy}} {( {r}_{x , i} - {\overline{r}}_{x} )}^{2}} {\sum }_{i ∈ {I}_{xy}} {( {r}_{y , i} - {\overline{r}}_{y} )}^{2}} \qquad ( 6 )$$

wherein x, y represent two different users; rₓ represents the vector of the product purchased by the user x, r_{x,i} represents the ith element in rₓ, r̅ₓ represents a result of an average value of all elements in rₓ; similarly, r_{y} represents the vector of the product purchased by the user y, r_{y,i} represents the ith element in r_{y}, r̅_{y} represents a result of an average value of all elements in r_{y}.

After one or more second users similar to the first user are determined, the historical behavior records of respective second users may constitute a content pool for selecting a recommended item. The content pool may include: product item; information item about product characteristics; information item about product service; information item about user's comments; information item about user's consulting, and the like.

Usually, the number of recommended items provided for the first user is limited. In order to optimize the recommended items, according to an embodiment of the present invention, the number of recommended items selected from a respective phase may be determined according to a weight allocated to the phase of the online decision process.

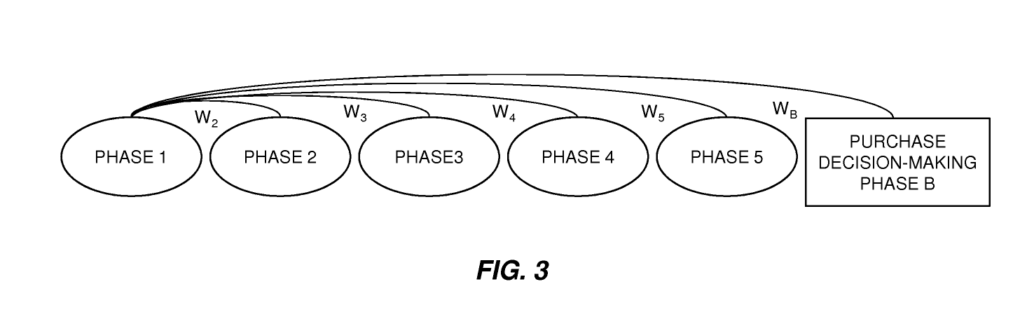

FIG. 3 illustrates an example of allocating a weight for each phase of the online purchase decision process according to an embodiment of the present invention. In the example illustrated in FIG. 3, the first user is determined to be presented in phase 1 of the online purchase decision process, and then phases 2, 3, 4, 5 having a higher purchase conversion rate than the determined phase and the purchase decision-making phase may be allocated different weights w2, w3, w4, w5 and wB to determine the number of recommended items selected from the respective phases.

For example, the following configuration may be applied: w2=1, wi=0, ∀i=3,4,5,B. This configuration corresponds to a solution where the second users can be selected from the users only in the next phase of the determined first user's phase. The configuration facilitates urging the potential buyer first user to convert to next phase to improve his probability in making the purchase decision.

Again for example, the following configuration may be presented: wB=1, wi=0, ∀i=2,3,4,5. This configuration corresponds to a solution where the second users can be selected only from the users who have already made the purchase decision. The configuration facilitates providing the potential buyer first user with the recommended items for which purchase conversion has already been performed finally.

Again for example, the following configuration may be presented: wi≠1, ∀i=2,3,4,5,B. This configuration corresponds to a solution where the second users can be selected from the users in all phases having a higher conversion rate than the determined first user's phase. The configuration facilitates extending the content pool of the recommended item to a maximum degree.

The weights allocated to different phases are configured artificially according to different demands. According to another preferred embodiment of the present invention, the weight of each phase may be adaptively updated according to whether the recommended item from this phase is adopted or not. For example, considering the product item from a particular phase i is finally purchased by the first user, the weight wᵢ^{new} allocated to the phase i may be updated according to the following equation:

wᵢ^{new}=(1−α)wᵢ^{old}+α*c (7)

wherein c is a positive constant which is, together with a parameter α, is used to determine how much the weight is increased progressively. After the new wᵢ^{new} is determined, the weights for all the current phases are normalized to make a sum thereof equal to 1.

Those skilled in the art may appreciate that the equation (7) only gives a specific example of updating the weight allocated for the phase i. Any method adapted to update the weights allocated for the respective phases in an adaptive learning manner may be used for the method of the present invention without departing from the essence of the present invention.

If the total number of recommended items provided for the first user is N, the number of recommended items selected from each phase may be determined according to the weights allocated to different phases. For example, the number Ni of recommended items allocated to the phase i may be determined as:

Nᵢ=└wᵢ*N┘, ∀i=1,2,3,4,5,B (8)

wherein └•┘ represents a floor function.

The above equation (8) only illustrates calculation of the number of recommended items allocated to phases by way of example. Those skilled in the art should appreciate that the number of recommended items allocated to respective phases may be determined in any suitable manner without departing from the essence of the present invention.

As stated above, the historical behavior records of all second users may constitute the content pool of the recommended items. In an embodiment, each content item in the content pool has a score for measuring its popularity. In the current recommendation system, there are already a plurality of solutions for scoring the popularity of the content item. According to the embodiment of the present invention, any suitable popularity scoring manner may be adopted without departing from the essence of the present invention. Therefore, for the sake of brevity, only a simple exampled is presented herein, and detailed depictions of the popularity scoring manners for the content items will not be presented herein.

For example, popularity for each product item in the content pool may be scored in the following manner:

sₚₒₚ₋ᵢₜₑₘ=f(number of items sold, dwelling time, visit frequency) (9)

Each comment item in the content pool may be scored in popularity in the following manner:

s_{pop-revw}=f(number of positive points, number of neutral points, number of negative points) (10)

According to an embodiment of the present invention, from the historical behavior records of the second user determined from each of one or more phases having a higher decision conversion rate than the phase determined for the first user, is selected content items of the number Ni determined for corresponding phases which have the highest popularity score, so as to serve as the recommended items to be provided for the first user.

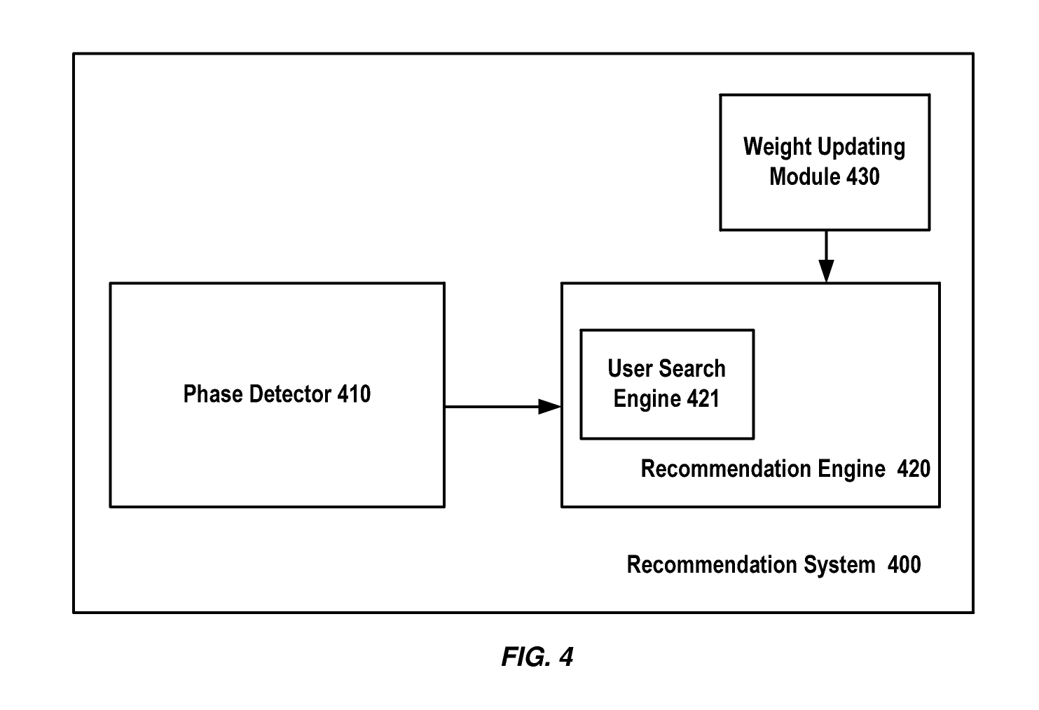

FIG. 4 illustrates a block diagram of a recommendation system according to an embodiment of the present invention.

As shown in FIG. 4, the recommendation system 400 comprises a phase detector 410 and a recommendation engine 420.

The phase detector 410 is configured to determine which phase of the decision process the first user is presented in, according to first user's behaviors in the online decision process. For example, in the online purchase system, the first user' behaviors may be monitored and detected by an operation capturing module (not shown) and a consultation and evaluation obtaining module (not shown) of the recommendation system 400. According to an embodiment of the present invention, the evaluation of the decision conversion rate may be performed according to the user's historical behaviors, and the decision process divided into phases according to the decision conversion rate. In a storage device (not shown) accessible by the phase detector 410 are stored user's behaviors and/or combinations of behaviors allocated to the respective phases as criteria for dividing the decision process into the respective phases.

The recommendation engine 420 is configured to select the recommended items to be provided to the first user according to the historical behavior records of one or more second users, wherein the one or more second users are users who are presented in one or more phases having a higher decision conversion rate than the determined phase.

According to an embodiment of the present invention, the recommendation engine 420 further comprises a user search engine 421. The user search engine 421 is configured to determine, from users in phases with a higher decision conversion rate than the determined phase, one or more users similar to the first user so as to serve as said one or more second users. If a similarity between the first user's decision behaviors and said another user's decision behaviors is greater than a threshold, the user search engine 421 determines that said another user is similar to the first user.

The recommendation engine 420 may further be configured to determine the number of recommended items selected from respective phases according to a weight allocated to each phase of the online decision process. According to an embodiment of the present invention, the system 400 may adaptively determine the weight allocated to each phase of the online decision process by using a weight updating module 430. The weight updating module 430 is configured to adaptively update the weight of the each phase according to whether the recommended items from this phase are adopted or not.

According to an embodiment of the present invention, the recommendation engine 420 may further be configured to select, from the historical behavior records of the second user determined from each of one or more phases having a higher decision conversion rate than the phase determined for the first user, content items of the number Ni determined for corresponding phases which have the highest popularity score so as to serve as the recommended items. According to an embodiment of the present invention, the recommended items selected by the recommendation engine 420 may include, but not limited to one or more selected from the following group: product item, information item about product characteristics, information item about product service, information item about user's comments, and information item about user's consulting.

A method according to one or more embodiments of the present invention allows for provision of the recommended items according to the phase of the online decision process which the first user is presented in, effectively pushes the first user to convert to a phase having a higher decision conversion rate, and thereby effectively improves the decision conversion rate of the whole decision process. Advantageously, one or more embodiments of the present invention can, according to actual needs, effectively control specific policies of providing the first user with the recommended items by configuring the weight allocated to each phase and/or adjusting a manner of updating the weight, thereby providing excellent flexibility and applicability.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented recommendation method, comprising:
determining, by a computer, according to a first user's behaviors in an online decision process, which phase of the online decision process the first user is presented in, wherein the decision process is divided into a plurality of phases depending on a decision conversion rate; and
selecting, by the computer, recommended items to be provided to the first user according to one or more second users' historical behavior records, wherein the one or more second users are users who are presented in one or more phases having a higher decision conversion rate than the determined phase.

2. The method according to claim 1, wherein the decision conversion rate is a ratio of the number of users having specific behaviors and having made the decision to the total number of users having the specific behaviors.

3. The method according to claim 2, wherein the online decision process includes a decision-making phase which has a decision conversion rate equal to 1.

4. The method according to claim 1, wherein the step of selecting the recommended items further comprises:
determining, by the computer, from users presented in the phases with a higher decision conversion rate than the determined phase, one or more users similar to the first user so as to serve as said one or more second users.

5. The method according to claim 4, wherein if a similarity of a decision behavior between the first user and another user is greater than a certain threshold, said another user is determined to be similar to the first user.

6. The method according to claim 4, wherein the step of selecting the recommended items further comprises:
determining, by the computer, the number of the recommended items selected from respective phases according to weights allocated to the respective phases of the online decision process,
wherein the weight of each phase is configured to be adaptively updated according to whether the recommended items from this phase are adopted or not.

7. The method according to claim 6, wherein the step of selecting the recommended items further comprises:
selecting, by the computer, from the historical behavior records of the second user determined from each of one or more phases having a higher decision conversion rate than the determined phase, content items of the number of recommended items determined for the respective phase which have the highest popularity score, so as to serve as the recommended items.

8. The method according to any one of claim 1, wherein the recommended items include one or more selected from the following group:
product item;
information item about product characteristics;
information item about product service;
information item about user's comments; and
information item about user's consulting.

9. A computer-implemented recommendation system, comprising:
a phase detector configured to determine, according to a first user's behaviors in an online decision process, which phase of the online decision process a first user is presented in, wherein the online decision process is divided into a plurality of phases depending on a decision conversion rate; and
a recommendation engine configured to select recommended items to be provided to the first user according to one or more second users' historical behavior records, wherein the one or more second users are users who are presented in one or more phases having a higher decision conversion rate than the determined phase.

10. The system according to claim 9, wherein the decision conversion rate is a ratio of the number of users having a specific behaviors and having made the decision to the total number of users having the specific behaviors.

11. The system according to claim 10, wherein the online decision process includes a decision-making phase which has a decision conversion rate equal to 1.

12. The system according to claim 9, wherein the recommendation engine further comprises:
a user search engine configured to determine, from users presented in the phases with a higher decision conversion rate than the determined phase, one or more users similar to the first user so as to serve as said one or more second users.

13. The system according to claim 12, wherein the user search engine is configured to determine, if a similarity of a decision behavior between the first user and another user is greater than a certain threshold, that said another user is similar to the first user.

14. The system according to claim 12, wherein the recommendation engine is configured to determine the number of the recommended items selected from respective phases according to weights allocated to the respective phases of the online decision process,
the system further comprises a weight updating module configured to adaptively update the weight of each phase according to whether the recommended items from this phase are adopted or not.

15. The system according to claim 14, wherein the recommendation engine is further configured to select, from the historical behavior records of the second user determined from each of one or more phases having a higher decision conversion rate than the determined phase, content items of the number of recommended items determined for the respective phase which have the highest popularity score, so as to serve as the recommended items.

16. The system according to any one of claim 9, wherein the recommended items include one or more selected from the following group:
product item;
information item about product characteristics;
information item about product service;
information item about user's comments;
information item about user's consulting.

17. A computer-implemented recommendation apparatus, comprising:
a module for determining, according to a first user's behaviors in an online decision process, which phase of the online decision process the first user is presented in, wherein the online decision process is divided into a plurality of phases depending on a decision conversion rate;
a module for selecting recommended items to be provided to the first user according to one or more second users' historical behavior records, wherein the one or more second users are users who are presented in one or more phases having a higher decision conversion rate than the determined phase.
